(19) United States
(12) Patent Application Publication
(10) Pub. No.: US 2005/0078338 A1
(43) Pub. Date: Apr. 14, 2005

(54) Image-forming apparatus and document information management method thereof

(76) Inventor: Jae-ho Kim, Maetan-dong (KR)

Correspondence Address: STANZIONE & KIM, LLP, 1740 N STREET, N.W., FIRST FLOOR, WASHINGTON, DC, 20036, US

(21) Appl. No.: 10/927,098

(22) Filed: Aug. 27, 2004

(30) Foreign Application Priority Data
Oct. 14, 2003 (KR) 2003-71337

(51) Int. Cl. G06F 15/00

(52) U.S. Cl. 358/1.16

(57) ABSTRACT

An image-forming apparatus and a document information management method. An image-forming apparatus at a transmission side which communicates with an image-forming apparatus at a reception side. The image-forming apparatus at the transmission side includes a first storage unit to store document data; a transmission/reception unit to receive a transmission request signal of the document data stored in the first storage unit from the image-forming apparatus at reception side; a second storage unit to store document management information having a facsimile number of the image-forming apparatus at reception side which has requested the transmission of the document data and transmission request dates in correspondence to the document data; and a control unit to control the document management information to be stored in the second storage unit if the transmission request signal is received, and reading out the document data corresponding to the transmission request signal from the first storage unit and transmitting the read-out document data to the image-forming apparatus at reception side. Accordingly, the present general inventive concept can separately store and manage information related to the transmissions of the document data that an external image-forming apparatus requests.

### CROSS-REFERENCE TO RELATED APPLICATIONS

This application claims the benefit of Korean Patent Application No. 2003-71337, filed on Oct. 14, 2003, in the Korean Intellectual Property Office, the disclosure of which is incorporated herein by reference.

### BACKGROUND OF THE INVENTION

1. Field of the Invention

The present general inventive concept relates to an image-forming apparatus and a document information management method thereof, and more particularly, to an image-forming apparatus and a document information management method thereof capable of storing, managing, and printing information related to transmissions of documents requested for transmission from external image-forming apparatuses.

2. Description of the Related Art

A multi function product can be an image-forming apparatus implementing operations of a photocopier, printer, facsimile machine, and scanner in one device. Such an image-forming apparatus can provide a print operation and/or a storage operation to store print data, e.g., document data. Further, if an image-forming apparatus provides a facsimile operation, the image-forming apparatus can transmit and receive document data to and from the other image-forming apparatus externally connected through a switching system. The document data can include diverse data such as data scanned by a scanner, data received through facsimiles, and data received by any other type of device.

Plural external image-forming apparatuses can receive, through the switching system, the document data stored in a particular image-forming apparatus. For example, if a certain image-forming apparatus receives, from an external image-forming apparatus, a transmission request of document data stored therein, the image-forming apparatus transmits the stored document data to the external image-forming apparatus.

However, if a conventional image-forming apparatus and plural external image-forming apparatuses are connected together, the conventional image-forming apparatus merely transmits document data upon receiving a transmission request, but does not manage in a separate manner information regarding when and to which external image-forming apparatus the document data has been transmitted. This can be inconvenient since a user cannot check information related to the document data transmitted to the external image-forming apparatus.

### SUMMARY OF THE INVENTION

Accordingly, it is an aspect of the present general inventive concept to provide an image-forming apparatus and document information management method capable of separately storing and managing information related to transmissions of document data that external image-forming apparatuses have requested.

Additional aspects and advantages of the present general inventive concept will be set forth in part in the description which follows and, in part, will be obvious from the description, or may be learned by practice of the present general inventive concept.

The foregoing and/or other aspects of the present general inventive concept are achieved by providing an image-forming apparatus at a transmission side, which can be connected to mutually communicate with at least one image-forming apparatus at a reception side, including a first storage unit to store data of at least one document, a transmission/reception unit to receive a transmission request signal of certain document data stored in the first storage unit from the image-forming apparatus at reception side, a second storage unit to store document management information having a facsimile number of the image-forming apparatus at reception side which has requested the certain document data and transmission request dates corresponding to the certain document data, and a control unit to control the document management information to be stored in the second storage unit if the transmission request signal is received from the image-forming apparatus at reception side, and to control the transmission/reception unit to read out the certain document data corresponding to the transmission request signal from the first storage unit and transmit the read-out document data to the image-forming apparatus at the reception side.

In an aspect of the present general inventive concept, the image-forming apparatus at the transmission side can further include a print unit to print the document management information stored in the second storage unit, wherein, if a print request signal is received for the document management information stored in the second storage unit, the control unit can control the print unit to read out the document management information from the second storage unit, can arrange the document management information in a predetermined pattern, and can print the arranged document management information.

The image-forming apparatus at the transmission side can further include a display unit to display the document management information stored in the second storage unit, wherein, if a display request signal is received for the document management information stored in the second storage unit, the control unit controls the display unit to read out the document management information from the second storage unit, arrange the document management information in a predetermined pattern, and display the arranged document management information.

Further, the control unit can arrange the document management information by a predetermined item, the item can be a type of document data, type of image-forming apparatus at reception side, and date of transmission request.

Further, if the transmission request signal is received, the control unit can control the second storage unit to store a number of times of transmission requests of the image-forming apparatus at the reception side by the certain document data.

The identification information of the image-forming apparatus at the reception side can be a facsimile number of the image-forming apparatus at the reception side which can be checked when a communication path is formed with the image-forming apparatus at the transmission side.

The foregoing and/or other aspects of the present general inventive concept can also be achieved by providing a method used with an image-forming apparatus at a transmission side, which can be connected for mutual communications with plural image-forming apparatuses at a reception side, the method including operations of storing data of at least one document, receiving a transmission request signal for certain document data stored in the storing operation from the image-forming apparatuses at the reception side, storing document management information having a facsimile number of the image-forming apparatuses at the reception side which have requested transmissions of the certain document data and transmission request dates if the transmission request signal is received, and reading out the certain document data corresponding to the transmission request signal and transmitting the certain document data to the image-forming apparatuses at the reception side.

In an aspect of the present general inventive concept, the document information management method can further include operations of receiving a print request signal of the stored document management information, reading out the stored document management information and arranging the read-out document management information in a predetermined pattern, and printing the arranged document management information.

The document information management method can further include operations of receiving a display request signal of the stored document management information, reading out the stored document management information and arranging the read-out document management information in a predetermined pattern, and displaying the arranged document management information.

The arranging operation can arrange the document management information under a predetermined item, the item comprising the type of document data, the type of image-forming apparatus at the reception side, and a date of the transmission request.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing a communication system having plural image-forming apparatuses connected to one another according to an embodiment of the present general inventive concept;

FIG. 2 is a schematic block diagram showing the first image-forming apparatus shown in FIG. 1 according to an embodiment of the present general inventive concept;

FIG. 3A and FIG. 3B are views illustrating document management information arranged in predetermined patterns; and

FIG. 4 is a flow chart explaining a document information management method of document data through the image-forming apparatus of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

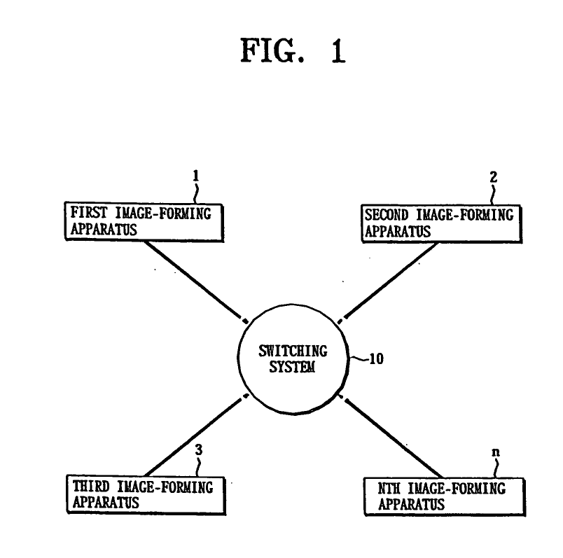

FIG. 1 is a view showing a communication system having plural image-forming apparatuses connected according to an embodiment of the present general inventive concept.

Referring to FIG. 1, plural image-forming apparatuses 1, 2, 3, . . . , n are connected to communicate with one another through a switching system 10. The plural image-forming apparatuses 1, 2, 3, . . . , n can be a multi function product providing operations such as a photocopier, printer, scanner, facsimile machine, etc. A switching system 10 can switch transmission paths among the respective image-forming apparatuses 1, 2, 3, . . . , n. Therefore, the plural image-forming apparatuses 1, 2, 3, . . . , n can share, through the switching system 10, certain document data stored in the respective image-forming apparatuses 1, 2, 3, . . . , n. That is, the plural image-forming apparatuses 1, 2, 3, . . . , n can transmit and receive stored document data to and from one another, and store and/or print the document data.

A description will follow wherein the second image-forming apparatus 2 is a receiver requesting a document data transmission and the first image-forming apparatus 1 is a transmitter transmitting the document data to the receiver.

If a transmission request for first document data stored in the first image-forming apparatus 1 is received from the second image-forming apparatus 2, the first image-forming apparatus 1 can read out the first document data stored therein and can transmit the same to the second image-forming apparatus 2. At the same time, the first image-forming apparatus 1 can store document management information related to the first document data such as the identification information, for example, a fax number of the second image-forming apparatus 2, the date and time on which the second image-forming apparatus 2 has requested the transmission of the first document data, the number of times that the second image-forming apparatus 2 has requested the transmission of the first document data, the total number of times of transmission requests for the first document data, and other related information. That is, the first image-forming apparatus 1 can store transmission management information.

Further, the transmission management information can include information related to document data which can be a target of the transmission request and image-forming apparatuses that have requested the transmissions of the document data. Such transmission management information can be updated when the plural external image-forming apparatuses 2, 3, . . . , n request transmissions of the first document data stored in the first image-forming apparatus 1, or the first image-forming apparatus 1 transmits the first document data to the external image-forming apparatuses 2, 3, . . . , n after the transmission requests of the first document data.

The first image-forming apparatus 1 can request the transmission of second document data stored in the second image-forming apparatus 2, and, if the second document data is received from the second image-forming apparatus 2 according to the transmission request, the first image-forming apparatus 1 can store document management information, that is, reception management information such as the number of times, dates, time, and so on, of the transmission requests of the second document data. The reception management information can be updated when the first image-forming apparatus 1 receives the second document data from the second image-forming apparatus 2 upon or after the transmission request of the second document data stored in the second image-forming apparatus 2.

The second image-forming apparatus 2 can recognize in advance document numbers, such as file names of the document data stored in a first sub-storage unit 174, which will be later described. Accordingly, if the second image-forming apparatus 2 has a communication path formed with the first image-forming apparatus 1, the second image-forming apparatus 2 can enter a transmission request mode, can select a document number of the first document data which is to be requested for transmission, and can transmit the document number. Thus, the first image-forming apparatus 1 can receive a transmission request signal of the first document data from the second image-forming apparatus 2 and to transmit the first document data to the second image-forming apparatus 2.

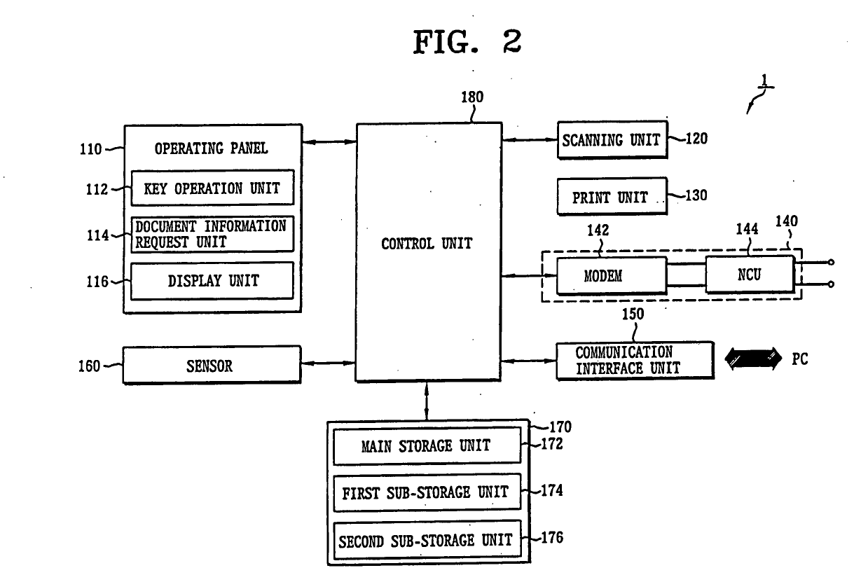

FIG. 2 is a schematic block diagram showing the first image-forming apparatus shown in FIG. 1 according to an embodiment of the present general inventive concept.

Referring to FIG. 1 and FIG. 2, the first image-forming apparatus 1 according to the present general inventive concept includes an operating panel 110, a scanning unit 120, a print unit 130, a transmission/reception unit 140, a communication interface unit 150, a sensor 160, a storage unit 170, and a control unit 180. The first image-forming apparatus 1 according to the present general inventive concept can be an apparatus that can manage information related to document data, which is referred to as “document management information”, to be transmitted to the plural external image-forming apparatuses 2, 3, . . . , n, and can store and can print the document management information.

The operating panel 110 has a key operation unit 112, a document information request unit 114, and a display unit 116.

The key operation unit 112 can be a user interface to output to a control unit, which will be described later, commands to set or carry out operations supported in the first image-forming apparatus 1. To do this, the key operation unit 112 can be provided with characters, numbers, various function keys to support direction inputs, or a touch screen. In particular, the key operation unit 112 can select an operation of photocopy mode, print mode, scanning mode, or data transmission/reception mode.

The document information request unit 114 can output to the control unit 180 at least one of a display request signal to display on the display unit 116 document management information of document data stored in the first sub-storage unit 174 and a print request signal to print the same through the print unit 130. As stated above, the document management information can be classified into transmission management information and reception management information, and stored in a second sub-storage unit.

The display unit 116 displays operation outputs of the first image-forming apparatus 1 with the controls of the control unit 180, and displays the document management information if the display request signal is outputted from the document information request unit 114. The display unit 116 can be generally implemented with a Liquid Crystal Display (LCD), or any other output device.

If any of the photocopy mode, scanning mode, and transmission mode is established, the scanning unit 120 can read out image data of a document to be scanned. The read-out image data can be stored in the first sub-storage unit 174 based on the controls of the control unit 180, or printed through the print unit 130.

The print unit 130 can print data which is to be printed, if a print command is applied to the print unit 130 from the key operation unit 112. For example, if the print command is applied with respect to document data externally received through the transmission/reception unit 140 to be described later, the print unit 130 prints the received document data based on the controls of the control unit 180.

The transmission/reception unit 140 can be a communication module which can carry out communication operations together with the plural external image-forming apparatuses 2, 3, . . . , n such as a facsimile machine externally connected. The transmission/reception unit 140 can transmit to the plural external image-forming apparatuses 2, 3, . . . , n document data stored in the first sub-storage unit 174, which will be described later. Further, the transmission/reception unit 140 can receive the transmission request signal with respect to the document data stored in the first sub-storage unit 174 from the plural external image-forming apparatuses 2, 3, . . . , n, or can receive document data stored in the plural external image-forming apparatuses 2, 3, . . . , n. The document data received from the plural external image-forming apparatuses 2, 3, . . . , n is printed through the print unit 130, stored in the first sub-storage unit 174, or transmitted to an external network(not shown) through the communication interface unit 150.

According to the present general inventive concept, the transmission/reception unit 140 can have a modem 142 and an NCU 144. The NCU 144 connects the switching system 10 and the modem 142, to thereby enable data transmissions and receptions with the plural external image-forming apparatuses 2, 3, . . . , n. One end of the general telephone network can be connected to the switching system 10.

The communication interface unit 150 can be connected with an external communication network (not shown), to thereby support mutual data communications. For example, the communication interface unit 150 can use a Universal Serial Bus (USB) module to form a network through a personal computer. Further, the communication interface unit 150 can provide communication paths with the plural external image-forming apparatuses 2, 3, . . . , n through the internet network.

The sensor 160 can check various states of the first image-forming apparatus 1 and can notify the control unit 180 of a check result.

The storage unit 170 can have a main storage unit 172, the first sub-storage unit 174, and a second sub-storage unit 176.

The main storage unit 172 can be a non-volatile memory that stores various control programs to perform operations of the first image-forming apparatus 1 and programs to convert to-be-printed data into image data.

The first sub-storage unit 174 can store detailed information on various document data and various data that are produced during the operations of the first image-forming apparatus 1. For example, the first sub-storage unit 174 stores document data or scanning data that are received from the plural external image-forming apparatuses 2, 3, . . . , n or an external network (not shown).

The second sub-storage unit 176 can store, in a lookup table format, the document management information classified into the transmission management information and the reception management information. That is, the transmission management information and the reception management information are stored by document or by external image-forming apparatuses 2, 3, . . . , n that have requested document transmissions. The document management information stored in the second sub-storage unit 176 can be entirely or partially deleted upon an input of a delete request signal of the key operation unit 112.

The control unit 180 can control the entire operations of the first image-forming apparatus 1 according to the control program stored in the main storage unit 172.

For example, if the scanning mode is selected, the control unit 180 can control the scanning unit 120 to scan a to-be-scanned document. Further, if the print mode is selected, the control unit 180 can convert document data into image data that the print unit 130 can recognize, and then can control the print unit 130 to print the converted data. Furthermore, if the data transmission mode is selected, the control unit 180 can control the transmission/reception unit 140 or the communication interface unit 150 to transmit certain document data to an external device such as the second image-forming apparatus 2 or a personal computer. Here, the document data to be printed refers to diverse data such as data received through the transmission/reception unit 140, data stored in the first sub-storage unit 174 or the second sub-storage unit 176, image data read out through the scanning unit 120, and so on.

In the present general inventive concept, if the transmission request signal is received requesting the first document data stored in the first sub-storage unit 174 from the second image-forming apparatus 2 of the plural external image-forming apparatuses 2, 3, . . . , n, the control unit 180 can control the second sub-storage unit 176 to store or update the document management information of the first document data.

The control unit 180 can update and store, for respective predetermined document data, the transmission management information having facsimile numbers of the second image-forming apparatus which has requested the transmissions of document data, and/or transmission request dates and times, and/or the number of times of transmission requests. The number of times of transmission requests refers to at least one of the total number of times of transmission requests of certain document data and the total number of times of transmission requests of certain document data by the plural external image-forming apparatuses 2, 3, . . . , n.

If the document management information of the certain document data is updated and stored in the second sub-storage unit 176, the control unit 180 can read out from the first sub-storage unit 174 certain document data corresponding to the transmission request signal. Further, the control unit 180 can control the transmission/reception unit 140 to transmit the read-out document data to the second image-forming apparatus 2.

If the display request signal is received from the document information request unit 114, the control unit 180 reads out the document management information stored in the second sub-storage unit 176 and arranges the same in a predetermined pattern. The control unit 180 can control the display unit 116 to display the document management information arranged in the predetermined pattern.

If the print request signal is received from the document information request unit 114, the control unit 180 reads out the document management information stored in the second sub-storage unit 176 and arranges the same in a predetermined pattern. Furthermore, the control unit 180 can convert the document management information arranged in the predetermined pattern into printable image data, and can control the control unit 130 to print the converted image data.

The predetermined pattern refers to a pattern arranging the document management information stored in the second sub-storage unit 176 by any of stored document data, the plural external image-forming apparatuses 2, 3, . . . , n, and transmission request dates.

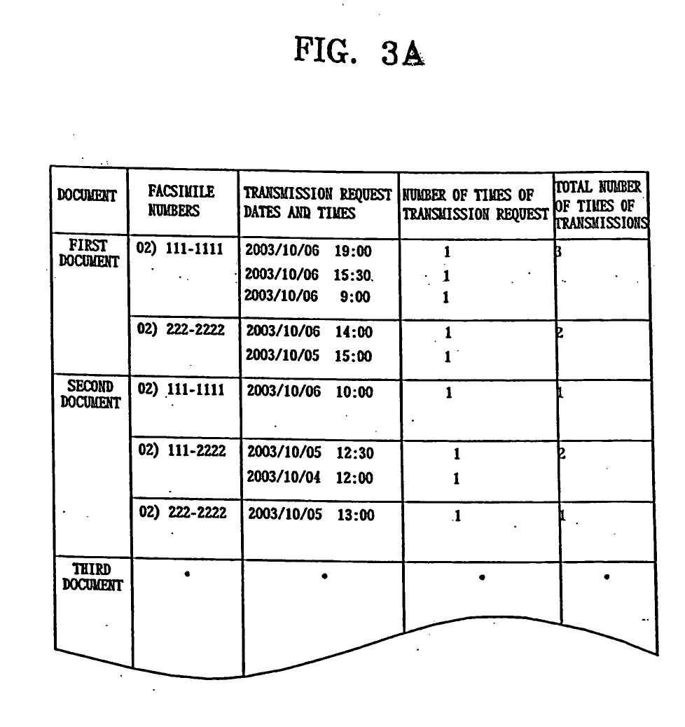

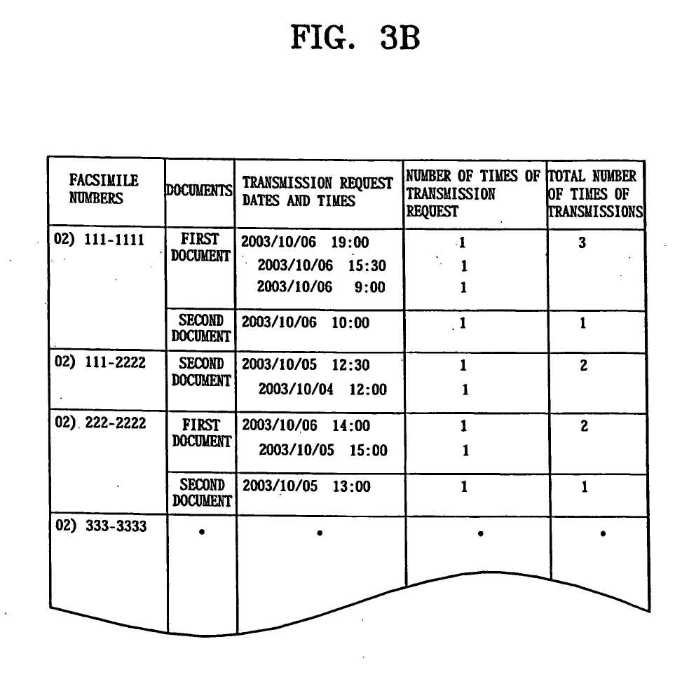

FIG. 3A and FIG. 3B are views illustrating document management information arranged in predetermined patterns.

FIG. 3A is a view illustrating how the document management information stored in the second sub-storage unit 176 can be arranged by document data. Referring to FIG. 3A, the control unit 180 can classify the document data stored in the second sub-storage unit 176 based on file names, and can ramify the document data based on the respective external image-forming apparatuses 2, 3, . . . , n. Furthermore, the control unit 180 can organize the document management information by the number of time, dates, and times of transmission requests of respective document data by the respective external image-forming apparatuses 2, 3, . . . , n.

FIG. 3B is a view illustrating that document management information stored in the second sub-storage unit 176 shown in FIG. 2 can be arranged by the plural external image-forming apparatuses shown in FIG. 1. FIG. 3B shows an implementation in an arrangement pattern similar to FIG. 3A, so that a detailed description of FIG. 3B will be omitted. However, the document management information shown in FIG. 3A and FIG. 3B is arranged according to the controls of the control unit 180, and displayed on the display unit 116 or printed through the print unit 130.

If the first image-forming apparatus 1 requests the transmission of the second document data stored in the second image-forming apparatus 2, the control unit 180 can store in the second sub-storage unit 176 the document management information such as the number of times, dates, time, and so on, of transmission requests of the second document data to the second image-forming apparatus 2. Together with the above description, the first image-forming apparatus 1 can read out the document management information stored in the second sub-storage unit 176, and display the same on the display unit 116 or print the same through the print unit 130. Accordingly, a user can easily check information on when and how many times the first image-forming apparatus 1 receives which document data from the external image-forming apparatuses 2, 3, . . . , n.

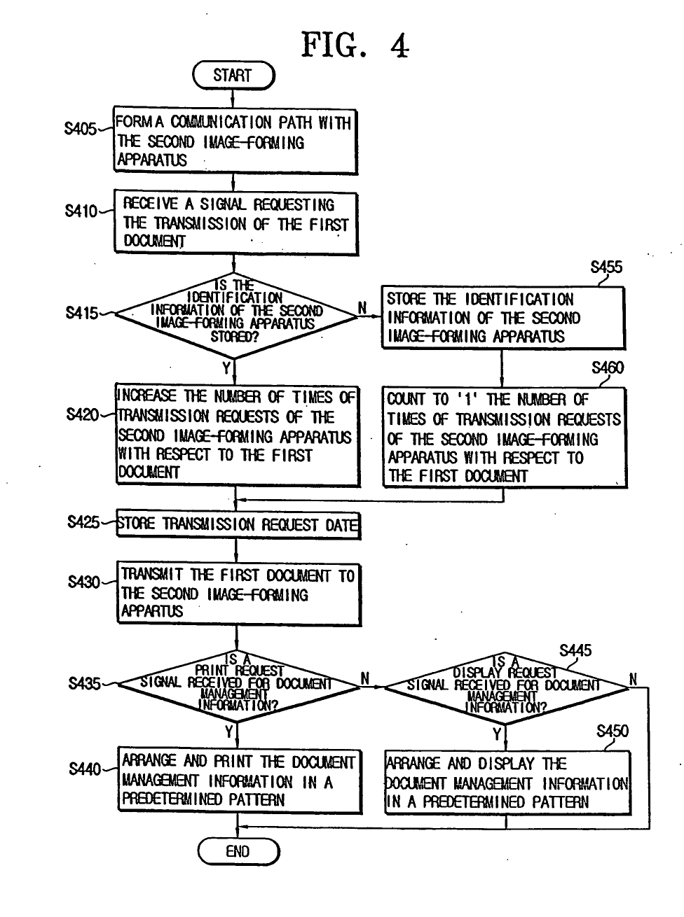

FIG. 4 is a flow chart explaining a method of managing document information of document data through the first image-forming apparatus of FIG. 2.

Referring to FIG. 1 to FIG. 4, a communication path can be formed between the first and second image-forming apparatuses 1 and 2 when there is a request of the second image-forming apparatus 2, in operation S405. After the communication path is formed, if a signal is received to request the transmission of first document data stored in the first sub-storage unit 174 from the second image-forming apparatus 2, the control unit 180 can check if identification information of the second image-forming apparatus 2, such as a facsimile number, is stored in the second sub-storage unit 176, in operations S410 and S415. The facsimile number of the second image-forming apparatus 2 can be checked through protocol transmissions in the communication path formation stage.

In operation S415, if it is checked that the facsimile number of the second image-forming apparatus 2 is stored in the second sub-storage unit 176, the control unit 180 can increase the number of times that the second image-forming apparatus 2 has requested transmissions of the first document data, in operation S420. At the same time, the control unit 180 can control the second sub-storage unit 176 to store the current date and time of the transmission request of the first document data in operation S425. Thus, the document management information, for example, the transmission management information on the first document data stored in the second sub-storage unit 176, can be updated and stored.

If operation S425 is carried out, the control unit 180 can read out the first document data from the first sub-storage unit 174, and can control the transmission/reception unit 140 to transmit the first document data to the second image-forming apparatus 2, in operation S430.

After a predetermined period of time lapses, when a print request signal for the document management information is received from the document information request unit 114, the control unit 180 can read out and arrange, in a predetermined pattern, the document management information stored in the second sub-storage unit 176. Further, after the control unit 180 converts the document management information arranged in the predetermined pattern into printable image data, the control unit 180 can control the print unit 130 to print the converted image data, in operations S435 and S440.

In the meantime, if a display request signal is received from the document information request unit 114 after operation S435 is performed, the control unit 180 can read out the document management information stored in the second sub-storage unit 176 and can arrange the same in a predetermined pattern. Further, the control unit 180 can control the display unit 116 to display the document management information arranged in the predetermined pattern, in operations S445 and S450.

In the meantime, if it is checked in operation S415 that the facsimile number of the second image-forming apparatus 2 is not stored, the control unit 180 can check the facsimile number of the second image-forming apparatus 2 from a protocol transmitted during the communication path formation, and can control the second sub-storage unit 176 to store the checked facsimile number, in operation S455. If operation S455 is carried out, the control unit 180 controls the second sub-storage unit 176 to count to “1” and store the number of times that the second image-forming apparatus 2 has requested the first document data, in operation S460. If operation S460 is carried out, the control unit 180 can carry out operations S425 and S450 again.

In a further embodiment of the present general inventive concept, the plural image-forming apparatuses 1, 2, 3, . . . , n can be connected through an Integrated Service Digital Network, Internet network (ISDN), and so on, in addition to the switching system 10. In such circumstances, the plural image-forming apparatuses 1, 2, 3, . . . , n can be each provided with a network interface allowing a communication network (not shown) to be used, or can use the communication interface unit 150.

The plural external image-forming apparatuses 2, 3, . . . , n can request a list of the document data stored in the first sub-storage unit 174. If the list is requested and the list of the document data transmitted from the first image-forming apparatus 1 is displayed on the plural external image-forming apparatuses 2, 3, . . . , n, the plural external image-forming apparatuses 2, 3, . . . , n can select the document data to be transmitted from the displayed list, and then can transmit a transmission request signal for the selected document data to the first image-forming apparatus 10 again.

Further, the image-forming apparatus according to the present general inventive concept has been explained with the first image-forming apparatus 1 shown in FIG. 2 as an example, but can also be applied to all the plural external image-forming apparatuses 1, 2, 3, . . . , n.

As described herein, the image-forming apparatus and document information management method according to the present general inventive concept can separately manage and store certain document data and the document information related to an image-forming apparatus as a receiver, if the transmission of the certain document data stored in an image-forming apparatus as a transmitter is requested from the image-forming apparatus as a receiver. Thus, by separately storing and printing identification information of the image-forming apparatus as a receiver requesting the transmission of the certain document data, dates and times of transmission requests, the number of times of transmission requests, and so on, users can easily check usage frequency and transmission frequency of document data, image-forming apparatuses as a receiver requesting transmissions, and so on.

Although a few embodiments of the present general inventive concept have been shown and described, it will be appreciated by those skilled in the art that changes may be made in these embodiments without departing from the principles and spirit of the present general inventive concept, the scope of which is defined in the appended claims and their equivalents.

1. An image-forming apparatus, at a transmission side, which is connected to mutually communicate with at least one image-forming apparatus at a reception side, comprising:
a first storage unit to store data of at least one document;
a transmission/reception unit to receive a transmission request signal of certain document data stored in the first storage unit from the image-forming apparatus at the reception side;
a second storage unit to store document management information having identification information of the image-forming apparatus at the reception side which has requested the certain document data and transmission request dates corresponding to the certain document data; and
a control unit to control the document management information to be stored in the second storage unit if the transmission request signal is received from the image-forming apparatus at the reception side, and to control the transmission/reception unit to read out the certain document data corresponding to the transmission request signal from the first storage unit and transmit the read-out document data to the image-forming apparatus at the reception side.

2. The image-forming apparatus as claimed in claim 1, further comprising a print unit to print the document management information stored in the second storage unit, wherein, if a print request signal is received for the document management information stored in the second storage unit, the control unit reads out the document management information from the second storage unit, arranges the document management information in a predetermined pattern, and controls the print unit to print the arranged document management information.

3. The image-forming apparatus as claimed in claim 1, further comprising a display unit to display the document management information stored in the second storage unit, wherein, if a display request signal is received for the document management information stored in the second storage unit, the control unit reads out the document management information from the second storage unit, arranges the document management information in a predetermined pattern, and controls the display unit to display the arranged document management information.

4. The image-forming apparatus as claimed in claim 2, wherein the control unit arranges the document management information by a predetermined item, the item comprising type of document data, type of image-forming apparatus at the reception side, and date of transmission request.

5. The image-forming apparatus as claimed in claim 1, wherein, if the transmission request signal is received, the control unit controls the second storage unit to store the number of times of transmission requests of the image-forming apparatus at the reception side by the certain document data.

6. The image-forming apparatus as claimed in claim 1, wherein the identification information of the image-forming apparatus at the reception side is a facsimile number of the image-forming apparatus at the reception side which is checked when a communication path is formed with the image-forming apparatus at the transmission side.

7. A document management system, comprising:
a storage unit to store document management information related to document data, the document management information comprising identification information of a requesting image forming apparatus that requests the document data and transmission request dates of the requested document data;
a transmission/reception unit to receive a transmission request signal of the certain document data stored in the storage unit from the requesting image forming apparatus; and
a control unit to control the document management information to be stored in the storage unit if the transmission request signal is received from the requesting image forming apparatus.

8. The system as recited in claim 7, wherein the storage unit comprises:
a first storage part to store the document data; and
a second storage part to store the document management information.

9. A document data management method of an image-forming apparatus at a transmission side, which is connected for mutual communications with plural image-forming apparatuses at a reception side, comprising the operations of:
storing data of at least one document;
receiving a transmission request signal for certain document data stored in the storing operation from the image-forming apparatuses at the reception side;
storing document management information having identification information of the image-forming apparatuses at the reception side which have requested transmissions of the certain document data and transmission request dates if the transmission request signal is received;
reading out the certain document data corresponding to the transmission request signal; and
transmitting the certain document data to the image-forming apparatuses at the reception side.

10. The document information management method as claimed in claim 9, further comprising the operations of:
receiving a print request signal for the stored document management information;
reading out the stored document management information and arranging the read-out document management information in a predetermined pattern; and
printing the arranged document management information.

11. The document information management method as claimed in claim 9, further comprising the operations of:
receiving a display request signal for the stored document management information;
reading out the stored document management information and arranging the read-out document management information in a predetermined pattern; and
displaying the arranged document management information.

12. The document information management method as claimed in claim 10, wherein the arranging operation arranges the document management information by a predetermined item, the item comprising a type of document data, a type of image-forming apparatus at the reception side, and a date of transmission requests.

13. The document information management method as claimed in claim 11, wherein the arranging operation arranges the document management information by a predetermined item, the item comprising a type of document data, a type of image-forming apparatus at reception side, and a date of transmission request.

14. The document information management method as claimed in claim 9, wherein the operation of storing the document management information stores a number of times of transmission requests of the image-forming apparatuses at the reception side by the certain document data.

15. The document information management method as claimed in claim 9, wherein the identification information of the image-forming apparatuses at the reception side is facsimile numbers of the image-forming apparatuses at the reception side which are checked when a communication path is formed with the image-forming apparatus at the transmission side prior to the operation of receiving the transmission request signal from the image-forming apparatuses at the reception side.

16. A computer readable storage medium storing a program controlling a computer to perform:
storing document management information related to an electronic request for a document by a requestor;
tabulating the document management information into tabulated document information; and
outputting the tabulated document information on an output device.
